(19) United States
(12) Patent Application Publication
(10) Pub. No.: US 2017/0047180 A1
(43) Pub. Date: Feb. 16, 2017

(54) SWITCH MODULE OF BUILT-IN ANTI-SURGE DISCONNECTION STRUCTURE

(71) Applicants: YI-HSIANG WANG, TAOYUAN CITY (TW); I-YING WANG, TAOYUAN CITY (TW)

(72) Inventors: YI-HSIANG WANG, TAOYUAN CITY (TW); I-YING WANG, TAOYUAN CITY (TW)

(21) Appl. No.: 14/824,211

(22) Filed: Aug. 12, 2015

(51) Int. Cl. H01H 37/76; H01H 37/34

(52) U.S. Cl. CPC H01H 37/761; H01H 37/34; H01H 2037/762; H01H 2205/002

(57) ABSTRACT

A switch module of built-in anti-surge disconnection structure mainly comprises an overcurrent protection switch and has anti-surge and disconnection structures ingeniously built inside a fire-proof and heat-resisting housing. The present invention comprises a switch area formed by a binary alloy conductive spring leaf and two connecting points, an anti-surge area formed by at least one bare metal oxide varistor placed in the housing and a plurality of conductive plates, and a disconnection area formed by a spring element, a band, and a thermo-sensitive piece. When the connecting points in the switch area are contacting with each other—turning on the switch—and an overvoltage occurs, the temperature of the metal oxide varistor would suddenly rise up to a degree higher than a pre-determined number, melting the thermo-sensitive piece, loosening and displacing the band, thus ejecting the spring element and forcing the connecting points detaching from each other to turn off the switch, so as to ensure more of electricity safety.

### BACKGROUND OF THE INVENTION

1. Field of the Invention

The present invention relates to a switch module of built-in anti-surge disconnection structure, particularly to an overcurrent protection switch that has anti-surge and disconnection structures built inside.

2. Description of the Related Art

FIGS. 1A and 1B disclose a conventional overcurrent protection switch 10 that has plural connecting points arranged in the middle part and comprises a housing 11 with a press button 12 on the top, a first terminal 12a, a second terminal 12b, a third terminal 12c separately arranged at the bottom, and a moving element 14. The first terminal 12a has a bimetal plate 13 and a first contact 131; the second terminal 12b has a second contact 121 corresponding to the first contact 131. The moving element 14 has one end linking the bottom of the press button 12 and the other linking the moving terminal of the bimetal plate 13, whereby the pressing of the press button 12 actuates the first contact 131 connecting to the second contact 121 and therefore turns on the device; while overcurrent occurs, the bimetal plate 13 deforms due to high degree of temperature and disconnects the first and second contact 131, 121, turning off the device so as to form an overcurrent protection switch 10. Such structure can be found in Taiwan patent applications No. 540811, 367091, 320335, 262168, and 208384. However, the structure disclosed above aims at protection from overcurrent situation but is not able to protect the device when sudden overvoltage such as lightning strike occurs.

Therefore, for safety concern, a usual solution to the defect is to parallel connect to a metal oxide varistor, and to connect to a thermal fuse in series.

FIG. 2A is the invention of U.S. Pat. No. 8,643,462. It discloses an anti-surge switch module applied in an electric system. The switch module comprises a power switch 105, an insulating member 106, a surge absorber 107 and a pyrocondensation belt 108. The insulating member 106 engages with the power switch 105 that abutting against the surge absorber 107; and the pyrocondensation belt 108 ties the surge absorber 107 and the insulating member 106 together so that it could contract when receiving the heat from the surge absorber 107 and thus turn off the power switch 105 under certain degree of contracting. However, the insulating member 106, the surge absorber 107 and the pyrocondensation belt 108 are not disposed inside the power switch 105 but are connected outside, failing to form a complete device with the power switch 105.

In short, the structures disclosed above have shortcomings as uncertain quality, possible exceeding heat due to external connection of components, slow reaction, large volumes, and complicated composition, and they require more constructing space and procedures. Besides, the protection device has to be connected independently outside instead of having one inside.

In UL 1449 3^{rd} Edition (2009) Type 4 was added to Surge Protective Devices (SPDs) requirements. The 3^{rd} Edition also includes the Low voltage Surge Arresters under 1000 V in the requirements, and the title is also altered from Transient Voltage Surge Suppressors into Surge Protective Devices. This shows the importance of integrating the components and the surge arresters function of the device.

Hence, the inventor has U.S. patent application Ser. No. 14/617,000 to construct an anti-surge disconnection structure built inside a heat-resisting and fireproof housing of an overcurrent protection switch so that the disconnection could be operated successfully and instantly when an overload occurs. However, the structure of the patent application has plural connecting points arranged in the middle part only in accordance with FIGS. 1A and 1B.

Also, there are different switch modules on the market. Those have plural connecting points arranged aside like the switch module shown in FIG. 2B have been disclosed in Taiwanese patent publication No. 529230 and 320335; Taiwanese patent No. M493139, M274630, M270478, and M461866 also have similar devices. Such switch modules commonly comprises a housing 11, a press button 12, a first terminal 12a, a second terminal 12b, a third terminal 12c, a binary metal alloy conductive piece 13a, a first connecting point 131, a second connecting point 121, and a moving rod 142. The difference among these modules is the arrangement of the binary metal alloy conductive piece 13a—whether it is a flat piece or a folded piece, which decides the place of the first connecting point 131, aside or in the middle. The inventor has continued to develop such feature and further designed a switch module 10 that allows the connecting point to be arranged either aside or in the middle as shown in FIGS. 1B and 2B.

### SUMMARY OF THE INVENTION

A primary object of the present invention is to provide a switch module of built-in anti-surge disconnection structure that has the original function of overcurrent protection and further includes anti-surge and disconnection structures to ensure more of electricity safety.

Another object of the present invention is to have the anti-surge and disconnection structures built inside the switch module for more safety and easy assembly with other electronic devices.

To achieve the objects mentioned above, the present invention comprises a housing having a press button arranged atop thereof, and a first conductive plate, a second conductive plate and a third conductive plate arranged at lower section thereof; the first conductive plate connecting to a binary alloy conductive spring leaf that has a first connecting point, and the second conductive plate having a second connecting point on the surface of an upper section thereof corresponding to the first connecting point; a moving rod linking up the bottom of the press button with one end and a free end of the binary alloy conductive spring leaf with the other end to make the first connecting point contacting the second conductive plate and turn on the switch, and detach the first and second connecting points to turn off the switch by having the binary alloy conductive spring leaf deformed due to high temperature when current overload occurs, so as to form an overcurrent protection switch that has a switch area formed by the binary alloy conductive spring leaf and the first and second connecting points; wherein an anti-surge disconnection structure is built inside the housing, including an anti-surge structure and a disconnection structure; the anti-surge structure including at least one bare metal oxide varistor without insulation layer wrapping from the outside, having a top surface and a bottom surface, and being disposed between the first and third conductive plate, so as to form an anti-surge area; the disconnection structure including a spring element disposed on the opposite side of the anti-surge area to be ejected by the binary alloy conductive spring leaf, which has no contacts with the binary alloy conductive spring leaf and the moving rod when being compressed; and a pushing rod arranged at the top of the spring element; a band having a first end and a second end arranged correspondingly, at least one of which being disposed close to the surface of the metal oxide varistor for compressing the spring element to keep a distance between the spring element and the binary alloy conductive spring leaf; at least one thermo-sensitive piece that is solid colloid to be adhered on the surface of the metal oxide varistor, which would loosen and displace the band and counterbalance the pressing on the top of the spring element when melting, so as to form a disconnection area; whereby when the first connecting point is contacting the second connecting point and an overvoltage occurs, the temperature of the metal oxide varistor would suddenly rise up to a degree higher than a pre-determined number, melting the thermo-sensitive piece, loosening and displacing the band, and thus ejecting the spring element to displace the pushing rod and upwardly flick the binary alloy conductive spring leaf, the moving rod, the press button, or any of the combination from these elements, force the first connecting point of the binary alloy conductive spring leaf detaching from the second connecting point and turn off the switch.

As structures disclosed above, the present invention complements the defect of a conventional overcurrent protection switch that it has to connect to a metal oxide varistor from the outside by having an anti-surge disconnection structure ingeniously built inside the heat-resisting and fireproof housing. When receiving exceedingly high voltages, the heating metal oxide varistor would instantly melt the thermo-sensitive piece down, loosening the band, ejecting the spring element and further displacing the pushing rod, therefore forcing the first connecting point detaching from the second connecting point and turning off the switch immediately. Therefore, the present invention is not only overcurrent protective but also overvoltage protective and surge absorbing, ensuring more electricity safety and conveniences in using.

### BRIEF DESCRIPTION OF THE DRAWINGS

FIG. 1A is a perspective view of an overcurrent protection switch according to the prior art;

FIG. 1B is a section view of an overcurrent protection switch according to the prior art;

FIG. 2A is a perspective view of an anti-surge disconnection structure according to U.S. Pat. No. 8,643,462;

FIG. 2B is another section view of an overcurrent protection switch according to the prior art;

FIG. 3 is a sectional view of the present invention in a preferred embodiment in an OFF status;

FIG. 3A is a partially enlarged view of FIG. 3;

FIG. 4 is a sectional view of the present invention in a preferred embodiment in an ON status;

FIG. 5 is an application example of the present invention illustrating the thermo-sensitive piece melting, loosening the band, displacing the pushing rod, and further turning the switch off;

FIG. 6 is an exploded view of the major components of the present invention in a preferred embodiment;

FIG. 7A is a schematic diagram of the present invention with two metal dioxide varistors;

FIG. 7B is a schematic diagram of the present invention with two metal dioxide varistors and the structure of the fourth conductive plate and the band; and

FIG. 7C is a schematic diagram of the present invention with three metal dioxide varistors and the structure of the fourth conductive plate and the band.

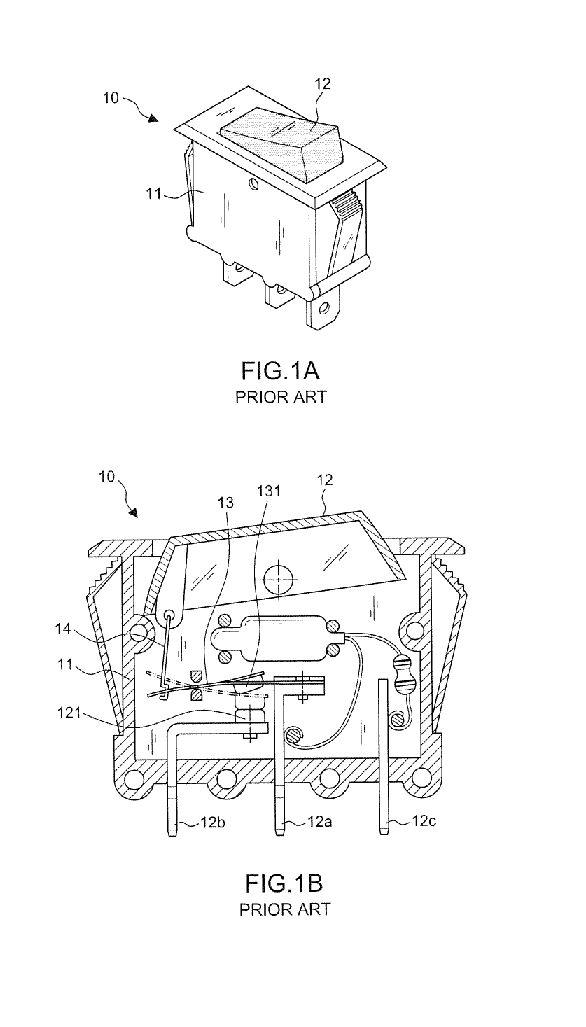

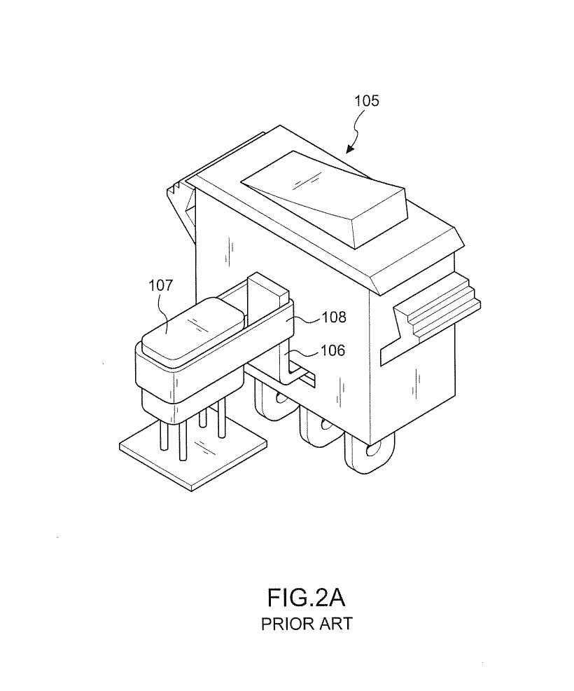

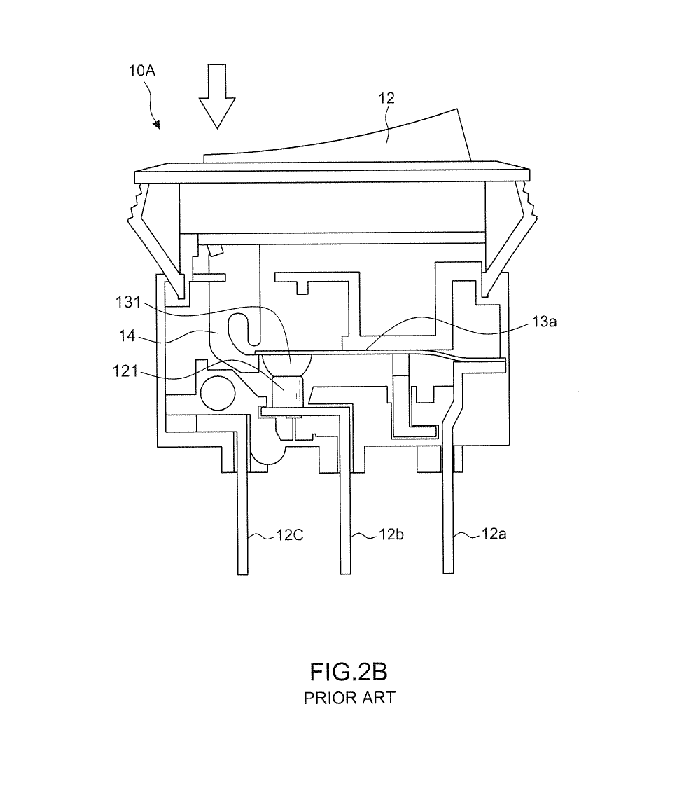

### DETAILED DESCRIPTION OF THE PREFERRED EMBODIMENT

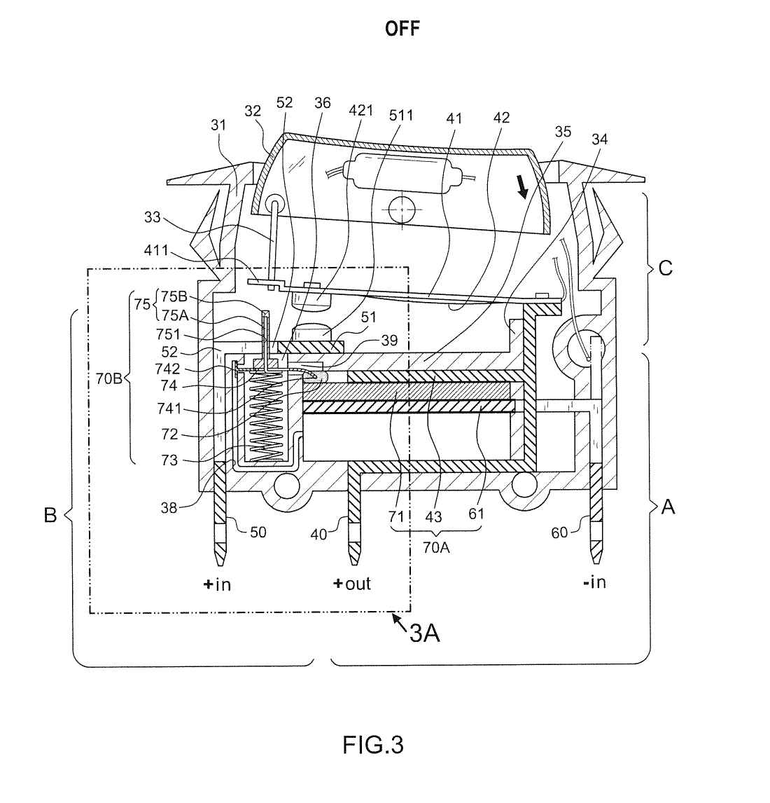

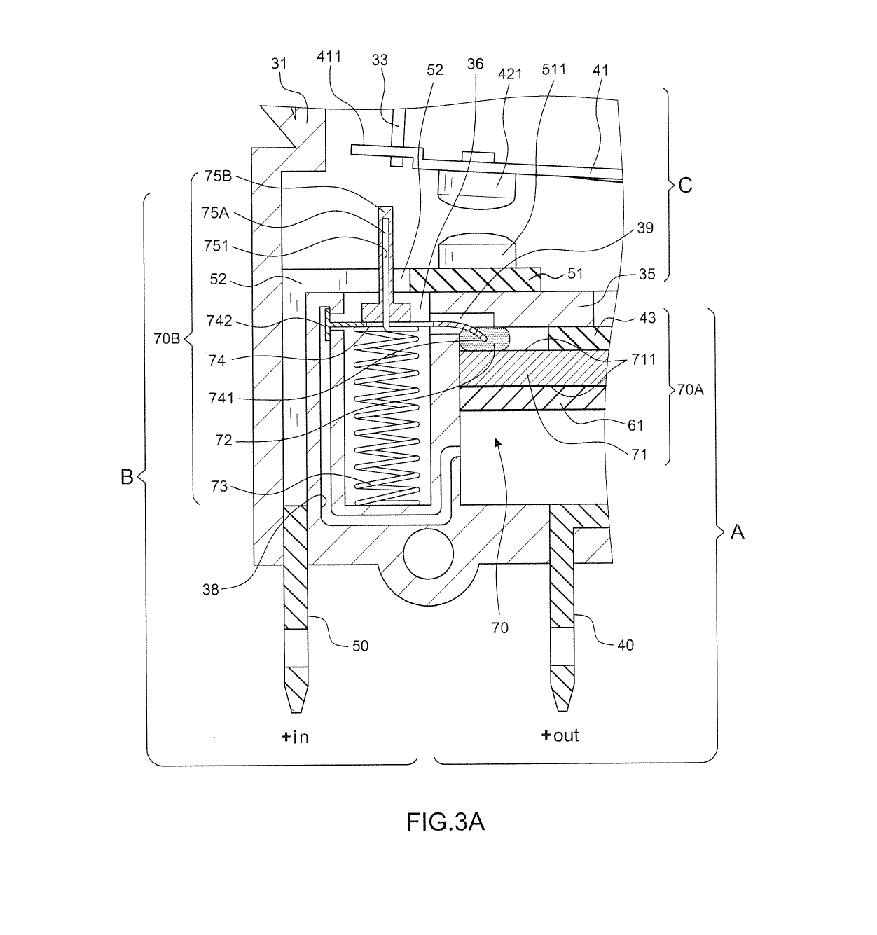

Referring to FIGS. 3-6, a preferred embodiment of the present invention mainly comprises a housing 31, a moving rod 33, an anti-surge disconnection structure 70, a band 74, at least one thermo-sensitive piece 72, and a pushing rod 75.

The housing 31 has a press button 32 arranged atop thereof, and a first conductive plate 40 for positive electrode output, a second conductive plate 50 for positive electrode input and a third conductive plate 60 for negative electrode input arranged at lower section thereof. The first conductive plate 40 connects to a binary alloy conductive spring leaf 41 that has a first connecting point 421, and the second conductive plate 50 has a second connecting point 511 corresponding to the first connecting point 421.

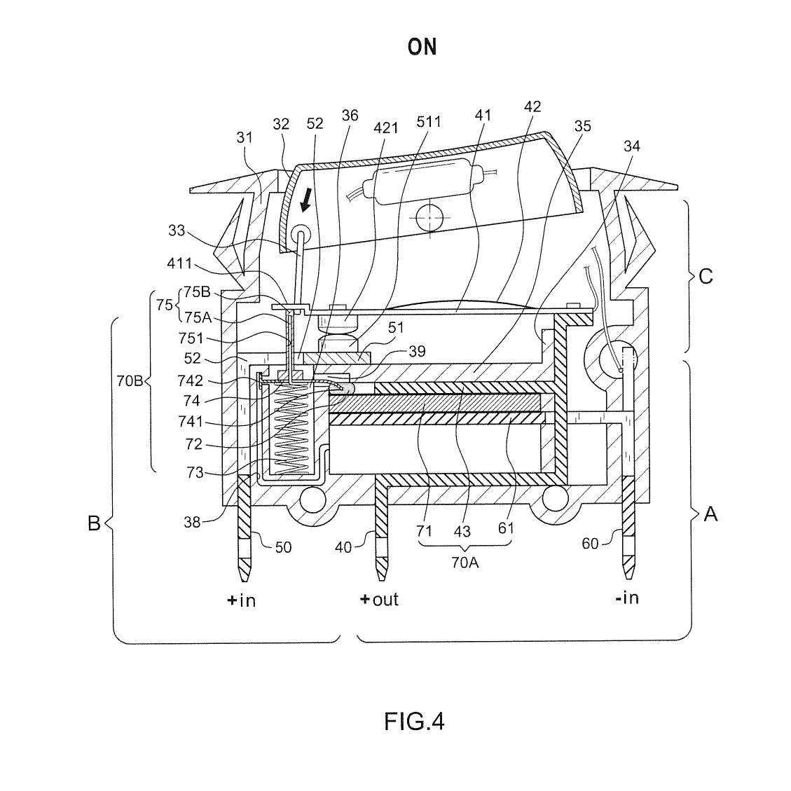

The moving rod 33 has a top end arranged at the bottom of the press button 32 and a bottom end connecting to a free end 411 of the binary alloy conductive spring leaf 41. With reference to FIG. 4, when pressing the press button 32, the binary alloy conductive spring leaf 41 is ejected downwards to make the first connecting point 421 contacting the second conductive plate 511 and turn on the switch; when current overload occurs, the binary alloy conductive spring leaf 41 deforms due to high temperature and detach the first connecting point 421 from the second connecting point 511 to turn off the switch—i.e. back to the status as shown in FIG. 3—so as to form a switch module 30 with an overcurrent protection switch.

In addition, the arrangement of the binary alloy conductive spring leaf 41 and the press button 32 is different in various switch modules. In this embodiment, the binary alloy conductive spring leaf 41 has a curved surface 42 and the first connecting point 421 is arranged aside of the binary alloy conductive spring leaf 41.

The features of the present invention lies in that the switch module 30 of the present invention has the anti-surge disconnection structure 70 built inside the housing 31, including an anti-surge structure 70A and a disconnection structure 70B in an applicable embodiment. The anti-surge structure 70A includes at least one bare metal oxide varistor 71 without insulation layer wrapping from the outside having a surface 711 includes a top surface and a bottom surface that can conduct both electricity and heat to conduct the heat rapidly and directly with the thermo-sensitive piece 72, and that are disposed between the first and third conductive plate 40, 60 for connection, forming a conductive structure and further an anti-surge area A. The disconnection structure 70B includes a spring element 73 disposed inside the housing 31, on the opposite side of the upper, lower, or side surface of the anti-surge area A to be ejected by the binary alloy conductive spring leaf 41; the spring element 73 has no contacts with the binary alloy conductive spring leaf 41 and the moving rod 33 when being compressed. In this embodiment, the spring element 73 is made of a column shaped spring but is not limited to such application. It can also be made of a spring piece or disposed next to the anti-surge area A or a disc spring disposed above or below anti-surge area A.

The band 74 has a first end 741 and a second end 742 arranged correspondingly, at least one of which is disposed close to the surface 711 of the metal oxide varistor 71 for compressing the spring element 73, therefore keep a distance from the binary alloy conductive spring leaf 41 and the moving rod 33. The spring element 73 is applicable in plates, banding, ropes, threads, or any of the composition of which.

The thermo-sensitive piece 72 is solid colloid to be adhered and fix an end of the band 74 on the surface 711 o f the metal oxide varistor 71. In this embodiment, the thermo-sensitive piece 72 fixes the first end 741 of the band 74 on the surface 711 of the metal oxide varistor 71, and the second end 742 thereof is fixed at a pre-determined position inside the housing 31 with adhesives after compressing and running across the spring element 73 through a dented passage 38. Also, the thermos-sensitive piece 72 is made of non-metal thermo-sensitive materials or metal compounds that are fast-acting in low temperature, e.g. common metal compounds in producing fuses, but the present invention is not limited to such application; materials those would melt at the pre-determined degree before the temperature of the metal oxide varistor 71 rises up to a high number would apply, conductive or not. Such compounds react fast with a regular melting point. In addition, the materials for the thermo-sensitive piece 72 and the band 74 can be any combination within metal and non-metal materials. For example, the band 74 made of metal materials with the thermo-sensitive piece 72 made of non-metal materials, both made of metal materials, or both made of thermo-sensitive materials would apply.

The pushing rod 75 is arranged atop the spring element 73 for operation. In this embodiment, the pushing rod 75 is a column 75A formed in one-piece from the top of the spring element 73 and has an upper end close to the binary alloy conductive spring leaf 41 or to the moving rod 33 so that when the binary alloy conductive spring leaf 41, the moving rod 33, the press button 32, or any of the combination of which is pushed or touched, the first connecting point 421 of the binary alloy conductive spring leaf 41 would be forced to detach from the second connecting point 511. Or the pushing rod 75 is an independent bar 75B having a bottom end thereof arranged at the top of the spring element 73 and an upper end thereof close to the binary alloy conductive spring leaf 41 or to the moving rod 33 so that when the spring element 73 is ejected, the first connecting point 421 of the binary alloy conductive spring leaf 41 would also be forced to detach from the second connecting point 511. It is also applicable in that the bar 75B further has an engaging hole 751 at the bottom thereof to be mounted on the top of the column 75A for engaging in position and simultaneously displacement. In short, the function of the pushing rod 75 is to push and eject the binary alloy conductive spring leaf 41, the moving rod 33, the press button 32, or any of the combination of which to force the first connecting point 421 detaching from the second connecting point 511.

When it is necessary to use metal materials for producing the spring element 73 and the band 74, the band can have an insulating element linking in-between to make sure that it would not conduct electricity. When the binary alloy conductive spring leaf 41 and the spring element 73 and the band 74 made of metal materials have the same electrode, the pushing rod 75 and the spring element 73 can be regarded as one component.

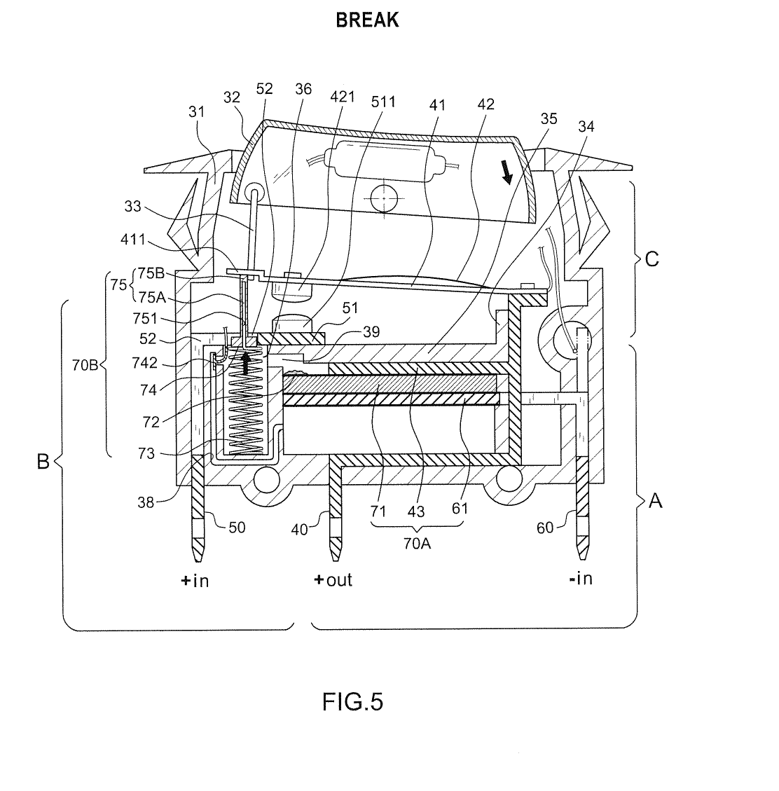

Further referring to FIG. 5, when the first connecting point 421 is contacting the second connecting point 511 and an overvoltage occurs, the temperature of the metal oxide varistor 71 would suddenly rise up to a degree higher than the melting point of the thermo-sensitive piece 72, and the thermo-sensitive piece 72 would melt, loosening the band 74, counterbalancing the compressing force on the spring element 73 and further displacing the pushing rod 75 upwardly, therefore forcing the first connecting point 421 detaching from the second connecting point 511 and turning off the switch.

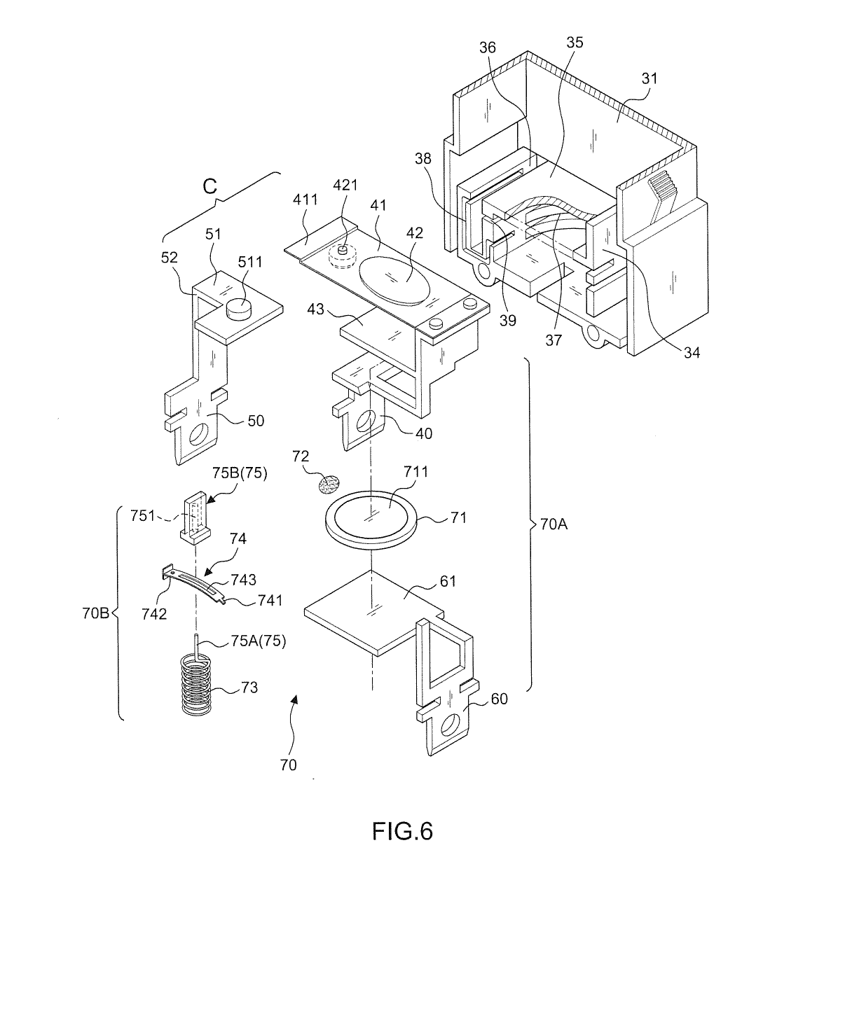

FIG. 6 is an exploded view of the main elements of the present invention. The anti-surge disconnection structure 70 mainly comprises an anti-surge structure 70A and a disconnection structure 70B. Meanwhile, with reference to FIGS. 3-5, in the embodiment the anti-surge disconnection structure 70 is arranged between the first conductive plate 40 and the third conductive plate 60, and the housing 31 has a vertical holding surface 34 and at least one horizontal positioning surface 35 arranged therein so that an upper section 51 of the second conductive plate 50 can be disposed on the positioning surface 35; the positioning surface 35 has a passage 36 arranged corresponding to the ejecting position of the binary alloy conductive spring leaf 41 for the spring element 73 to be disposed, and a space 39 for the band 74 to pass through. Furthermore, the housing 31 has at least one positioning groove 37 arranged between the first and third conductive plates 40, 60 for the metal oxide varistor 71 and the conductive plates to be engaged in position, so that the entire anti-surge structure 70 is steadily built inside the housing 30. In this embodiment, a first transverse piece 43 is arranged at the middle section of the first conductive plate 40, and the metal oxide varistor 71 is arranged at the bottom of the first transverse piece 43, and the third conductive plate 60 has a second transverse piece 61 arranged corresponding to the first transverse piece 43 so that the metal oxide varistor 71 is disposed between the first and second transverse pieces 43, 61. The surface 711 of the metal oxide varistor 71 is either fixedly or elastically contacting the conductive plates.

In brief, the housing 31 of the present invention has three areas within: a switch area C formed by the binary alloy conductive spring leaf 41, the first connecting point 421, and the second connecting point 511, an anti-surge area A formed by the anti-surge structure 70A, and a disconnection area B formed by the disconnection structure 70B. Among which only the switch area C would be disposed in different position as in different switch modules; the structure combining the anti-surge area A and the disconnection area B would be the same in different switch modules.

When an overvoltage occurs to the switch module 30 of the present invention, the temperature of the metal oxide varistor 71 instantly rises up to a pre-determined degree, melting the thermo-sensitive piece 72 on the upper surface 711 of the metal oxide varistor 71. A metal oxide varistor is an non-ohmic conductive component. The electric resistance of a metal oxide varistor depends on the external voltages. Therefore, the V-I characteristic curve of it is obviously non-linear, making it popularly used in the practical field for preventing the power supply system from the damages caused by sudden overvoltage. The thermo-sensitive piece 72 of the present invention would melt immediately when an overvoltage occurs and results in the instant rising of temperature of the metal oxide varistor 71, loosening the band 74, counterbalancing the compressing force on the spring element 73 and further displacing the pushing rod 75 upwardly, therefore forcing the first connecting point 421 detaching from the second connecting point 511 and turning off the switch in a short time.

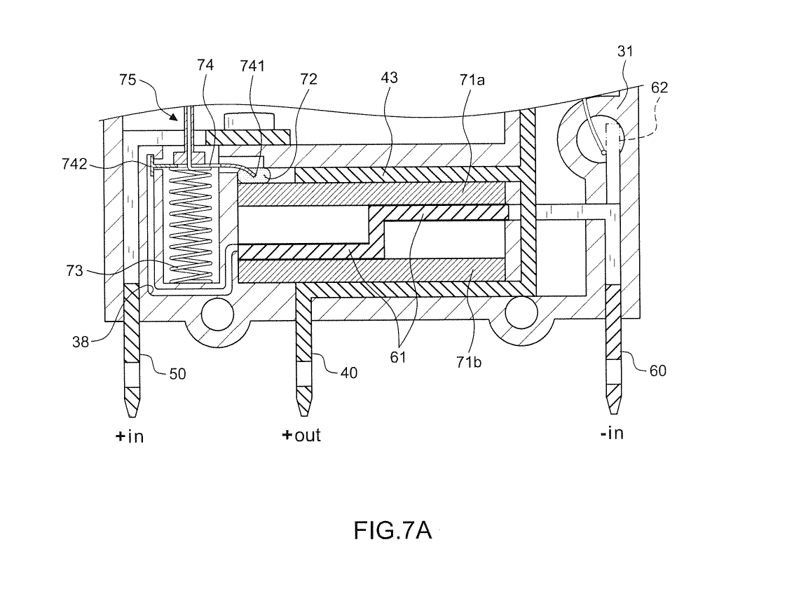

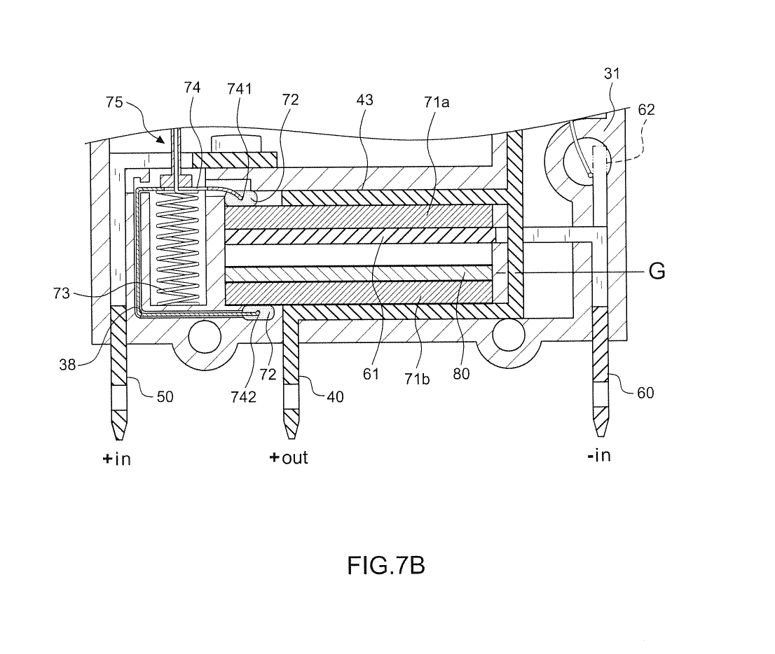

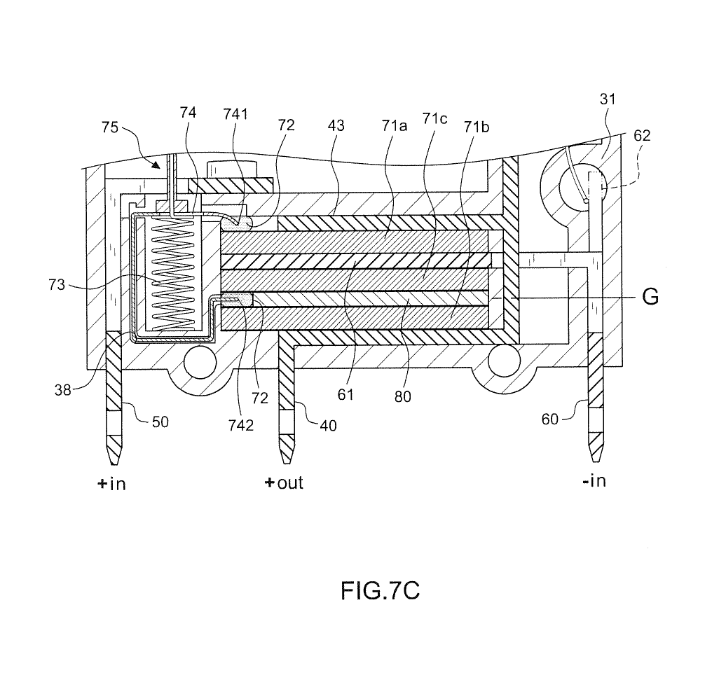

In the disclosed embodiments in accordance with FIGS. 3-6, there is one metal oxide varistor 71 but it is not limited to such application. In FIG. 7A, the present invention includes two parallel connected metal oxide varistors 71a, 71b to be combined with the band 74, enhancing the anti-surge function and enabling more rapid melting of the thermo-sensitive piece 72, ensuring more safety as well. In this embodiment, there is a first metal oxide varistor 71a and a second metal oxide varistor 71b. The thermo-sensitive piece 72 is fixing the first end 741 of the band 74 on the surface of the first metal oxide varistor 71a with adhesives, and the second end 742 of the band 74 is tightly fixed in a pre-determined position inside the housing 31 after compressing and running across the spring element 73. The second metal oxide varistor 71b is disposed between the second transverse piece 61 and the first conductive plate 40 below the second transverse piece 61, and the second transverse piece 61 is step-like to fix the position of the first metal oxide varistor 71a between the first and second transverse piece 43, 61.

FIG. 7B illustrates a simple three-pole surge absorbing structure of the present invention, including two metal oxide varistors 71a, 71b and a fourth conductive plate 80. The difference lies in that the fourth conductive plate 80 is added for absorbing the surge between the ground wire and the positive electrode. The first metal oxide varistor 71a is disposed below the first conductive plate 40 and the second metal oxide varistor 71b is disposed between the second transverse piece 61 and the first conductive plate 40. The thermo-sensitive piece 72 fixes the first end 741 of the band 74 on the surface of the first metal oxide varistor 71a with adhesives and has the second end 742 of the band 74 fixed on the surface of the second metal oxide varistor 71b after compressing and running across the spring element 73 and through a dented passage 38 arranged at a pre-determined position inside the housing 31; the second metal oxide varistor 71b further has a fourth conductive plate 80 on the surface thereof. With such structure, either metal oxide varistor can loosen the band 74 for operation.

FIG. 7B illustrates a complete three-pole surge absorbing structure of the present invention, including three metal oxide varistors 71a, 71b, 71c and a fourth conductive plate 80. The difference lies in that the third metal oxide varistor 71c is added. The third metal oxide varistor 71c is disposed below the second transverse piece 61 and above the fourth conductive plate 80. The thermo-sensitive piece 72 fixes the first end 741 of the band 74 on the surface of the first metal oxide varistor 71a with adhesives, and has the second end 742 of the band 74 fixed between the fourth conductive plate 80 and the second and third metal oxide varistor 71b, 71c with adhesives after compressing and running across the spring element 73 and through a dented passage 38 arranged at a pre-determined position inside the housing 31. With such structure, either metal oxide varistor can disconnect and stop the operation when encountering overloads.

From FIGS. 7A, 7B, and 7C, it is clear that having one or more metal oxide varistors would apply in the present invention, and that the arrangement of the anti-surge area A and the disconnection area B is adjustable in accordance with the position of the switch area C. It is also applicable to have other related components added to the structures.

With structures disclosed above, the present invention complements the defect of a conventional overcurrent protection switch that it has to connect to a metal oxide varistor and a thermal fuse from the outside by having an anti-surge disconnection structure 70 ingeniously built inside so that when receiving exceedingly high voltages, the heating metal oxide varistor 71 would instantly melt the thermo-sensitive piece 72, loosening the band 74, counterbalancing the compressing force on the spring element 73 and further displacing the pushing rod 75 upwardly, therefore forcing the connecting points to detach and turning off the switch immediately. Hence, the present invention has the original function of overcurrent protection and further has the overvoltage protection and anti-surge disconnection structures built inside, ensuring more electricity safety and conveniences in using.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A switch module of built-in anti-surge disconnection structure, comprising:
a housing having a press button arranged atop thereof, and a first conductive plate, a second conductive plate and a third conductive plate arranged at lower section thereof; the first conductive plate connecting to a binary alloy conductive spring leaf that has a first connecting point, and the second conductive plate having a second connecting point on the surface of an upper section thereof corresponding to the first connecting point;
a moving rod linking up the bottom of the press button with one end and the binary alloy conductive spring leaf with the other end to make the first connecting point contacting the second conductive plate and turn on the switch, and detach the first and second connecting points to turn off the switch by having the binary alloy conductive spring leaf deformed due to high temperature when current overload occurs, so as to form an overcurrent protection switch that has a switch area formed by the binary alloy conductive spring leaf and the first and second connecting points; wherein
an anti-surge disconnection structure is built inside the housing, including an anti-surge structure and a disconnection structure; the anti-surge structure including at least one bare metal oxide varistor without insulation layer wrapping from the outside, having a top surface and a bottom surface, and being disposed between the first and third conductive plate, so as to form an anti-surge area; the disconnection structure including a spring element disposed on the opposite side of the anti-surge area to be ejected by the binary alloy conductive spring leaf, which has no contacts with the binary alloy conductive spring leaf and the moving rod when being compressed; and a pushing rod arranged at the top of the spring element;
a band having a first end and a second end arranged correspondingly, at least one of which being disposed close to the surface of the metal oxide varistor for compressing the spring element to keep a distance between the spring element and the binary alloy conductive spring leaf;
at least one thermo-sensitive piece that is solid colloid to be adhered on the surface of the metal oxide varistor, which would loosen and displace the band and counterbalance the pressing on the top of the spring element when melting, so as to form a disconnection area;
whereby when the first connecting point is contacting the second connecting point and an overvoltage occurs, the temperature of the metal oxide varistor would suddenly rise up to a degree higher than a pre-determined number, melting the thermo-sensitive piece, loosening and displacing the band, and thus ejecting the spring element to displace the pushing rod and upwardly flick the binary alloy conductive spring leaf, the moving rod, the press button, or any of the combination from these elements, force the first connecting point of the binary alloy conductive spring leaf detaching from the second connecting point and turn off the switch.

2. The switch module of built-in anti-surge disconnection structure a s claimed in claim 1, wherein the pushing rod is a column formed in one-piece from top of the spring element and has an upper end close to the binary alloy conductive spring leaf or to the moving rod so that when the spring element is ejected, the first connecting point of the binary alloy conductive spring leaf would be forced to detach from the second connecting point.

3. The switch module of built-in anti-surge disconnection structure as claimed in claim 1, wherein the pushing rod is an independent bar, having a bottom end thereof arranged at the top of the spring element and an upper end thereof close to the binary alloy conductive spring leaf or to the moving rod so that when the spring element is ejected, the first connecting point of the binary alloy conductive spring leaf would be forced to detach from the second connecting point.

4. The switch module of built-in anti-surge disconnection structure as claimed in claim 3, wherein the bar has an engaging hole at the bottom thereof to be mounted on the top of the spring element for engaging in position, and it is made of insulating materials.

5. The switch module of built-in anti-surge disconnection structure as claimed in claim 1, wherein a first transverse piece is arranged at the middle section of the first conductive plate, and the metal oxide varistor is arranged at the bottom of the first transverse piece; and the third conductive plate has a second transverse piece arranged corresponding to the first transverse piece, so that the metal oxide varistor is disposed between the first and second transverse pieces.

6. The switch module of built-in anti-surge disconnection structure as claimed in claim 5, wherein the thermo-sensitive piece is disposed on a surface of the metal oxide varistor and is bond to one or both ends of the band.

7. The switch module of built-in anti-surge disconnection structure as claimed in claim 6, wherein there is one metal oxide varistor, and the thermo-sensitive piece is fixing the first end of the band on the surface of the metal oxide varistor; the second end of the band is tightly fixed in a pre-determined position inside the housing after compressing and running across the spring element.

8. The switch module of built-in anti-surge disconnection structure as claimed in claim 7, wherein there is a first metal oxide varistor and a second metal oxide varistor; the thermo-sensitive piece is fixing the first end of the band on the surface of the first metal oxide varistor with adhesives, and the second end of the band is tightly fixed in a pre-determined position inside the housing after compressing and running across the spring element; the second metal oxide varistor is disposed between the second transverse piece and the first conductive plate below the second transverse piece, and the second transverse piece is step-like to fix the position of the first metal oxide varistor between the first and second transverse piece.

9. The switch module of built-in anti-surge disconnection structure as claimed in claim 6, wherein there is a first metal oxide varistor and a second metal oxide varistor; the first metal oxide varistor is disposed below the first transverse piece and has the first end of the band fixed on the surface thereof while the second metal oxide varistor is disposed between the second transverse piece and the first conductive plate, and has the second end of the band fixed on the surface thereof after compressing and running across the spring element and through a dented passage arranged at a pre-determined position inside the housing; the second metal oxide varistor further has a fourth conductive plate of the surface thereof.

10. The switch module of built-in anti-surge disconnection structure as claimed in claim 9, wherein there is a first metal oxide varistor, a second metal oxide varistor, and a third metal oxide varistor; the third metal oxide varistor is disposed below the second transverse piece and a fourth conductive plate is disposed between the second and third metal oxide varistor; the first end of the band is fixed on the surface of the first metal oxide varistor with adhesives, and the second end of the band is fixed between the second and third metal oxide varistor with adhesives after compressing and running across the spring element and through a dented passage arranged at a pre-determined position inside the housing;
